(19) United States
(12) Patent Application Publication
(10) Pub. No.: US 2007/0212948 A1
(43) Pub. Date: Sep. 13, 2007

(54) Testing Pin Assembly And A Testing Apparatus With Such Assembly

(75) Inventor: Zhi Yong ZUO, Dongguan (CN)

Correspondence Address: WILLIAM J. SAPONE;COLEMAN SUDOL SAPONE P.C., 714 COLORADO AVENUE, BRIDGE PORT, CT, 06605, US

(73) Assignee: DONGGUAN CENTALIC ELECTRONIC TESTING PARTS CO. LTD, Dongguan (CN)

(21) Appl. No.: 11/456,008

(22) Filed: Jul. 6, 2006

(30) Foreign Application Priority Data
Mar. 7, 2006 (CN) 200620055854.0

(51) Int. Cl. H01R 13/24

(52) U.S. Cl. 439/700

(57) ABSTRACT

A testing pin assembly (200) is disclosed as including a pin (202) with a lower end, and a spring (206) electrically connected with the pin (202) via a connector (204), in which the connector (204) includes an upper surface (210) electrically connected with the lower end of the pin (202), and a lower end (212) of the connector (204) is partly received within a cavity of an end of the spring (206). An apparatus (300) for testing printed circuit boards (310) is disclosed as including the testing pin assembly (200), in which the spring (206) and the connector (204) are housed within a base (302), and the pin (202) extends through an opening (306) of a platform (308).

### TECHNICAL FIELD

This invention relates to a testing pin assembly and a testing apparatus with such an assembly, in particular such an assembly and an apparatus for testing printed circuit boards (PCB's).

### BACKGROUND

An exemplary testing apparatus with prior art testing pin assemblies for testing PCB's is shown in FIGS. 1 and 2, and generally designated as 100. The testing apparatus 100 includes a base 102 supported by a number of supporting columns 104. Within the base 102 are a number of vertical cylindrical through-holes 106, each receiving a spring 108.

Connected with a lower end of the spring 108 is an electric cable 110 which is in electrical connection with the spring 108 for providing electricity to the spring 108. A lower end of a testing pin 112 sits within a cavity of an upper end of the spring 108 and is in physical and electrical contact with the spring 108. Thus, electricity provided by the cable 110 may be supplied to the testing pin 112. The pins 112 extend through openings 120 in a number of platforms 122.

During testing, a PCB 114 to be tested is pressed downwardly so that points 116 to be tested are brought into contact with upper ends of the pins 112. Electricity may therefore be passed by the cables 110 to the points 116 for testing purposes.

Such a prior art arrangement suffers from the following drawbacks:

a. as shown in FIG. 1, during the testing of high-density PCB's, as the distance B between the points 116 to be tested may be different from, e.g. smaller than or wider than, the distance C between the vertical through-holes 106, one or more of the pins 112 have to be inclined relative to the through-holes 106, such that the pin 112 is inclined relative to the longitudinal axis of its respective spring 108 by an angle of less than 180°. The spring 108 will then be caused to rub or scratch against the base 102 (as shown in the part marked D in FIG. 2), thus causing damage to the spring 108 and affecting the results of the test;

b. the electric conductivity between the upper end of the spring 108 and the lower end of the pin 112 will decrease with use. The continuous rubbing or scratching between the lower end of the pin 112 and the upper end of the spring 108 will damage their coatings, producing debris (as shown in the part marked E in FIG. 2). Such will again reduce the electric conductivity, and affect the result of the tests;

c. the most easily damaged components in the testing apparatus 100 are the springs 108. However, as such are housed within the base 102, the base 102 and the cables 110 have to be disassembled and removed before even one defective spring 108 can be removed for replacement. Such is clearly cumbersome; and

d. it is necessary to produce the springs 108 such that the inner diameter of the upper end of the spring 108 is smaller than the diameter of the lower end of the pin 112. Such sets a high standard on the machines, moulds and techniques required for producing the springs 108, thus significantly increasing the production cost and difficulty.

It is thus an object of the present invention to provide a testing pin assembly and a testing apparatus with such an assembly in which the aforesaid shortcomings are mitigated, or at least to provide a useful alternative to the public.

### SUMMARY OF THE PRESENT INVENTION

According to a first aspect of the present invention, there is provided a testing pin assembly including a pin member with a lower end, and a spring member electrically connected with said pin member via a connector, wherein said connector includes an upper surface electrically connected with said lower end of said pin member, and wherein a lower end of said connector is at least partly received within a cavity of a first end of said spring member.

According to a second aspect of the present invention, there is provided an apparatus for testing printed circuit boards, including a testing pin assembly including a pin member with a lower end, and a spring member electrically connected with said pin member via a connector, wherein said connector includes an upper surface electrically connected with said lower end of said pin member, wherein a lower end of said connector is at least partly received within a cavity of a first end of said spring member, wherein said spring member and said connector are housed within a base member, and wherein said pin member extends through an opening of a platform member.

### BRIEF DESCRIPTION OF THE DRAWINGS

A preferred embodiment of the present invention will now be described, by way of example only, with reference to the accompanying drawings, in which:

FIG. 1 is a schematic diagram of a prior art apparatus for testing printed circuit boards;

FIG. 2 is an enlarged view of the encircled part marked A in FIG. 1;

FIG. 3 is a schematic diagram of a testing pin assembly according to a preferred embodiment of the present invention;

FIG. 4 is a schematic diagram of an apparatus for testing printed circuit boards according to a preferred embodiment of the present invention; and

FIG. 5 is an enlarged view of the encircled part in FIG. 4.

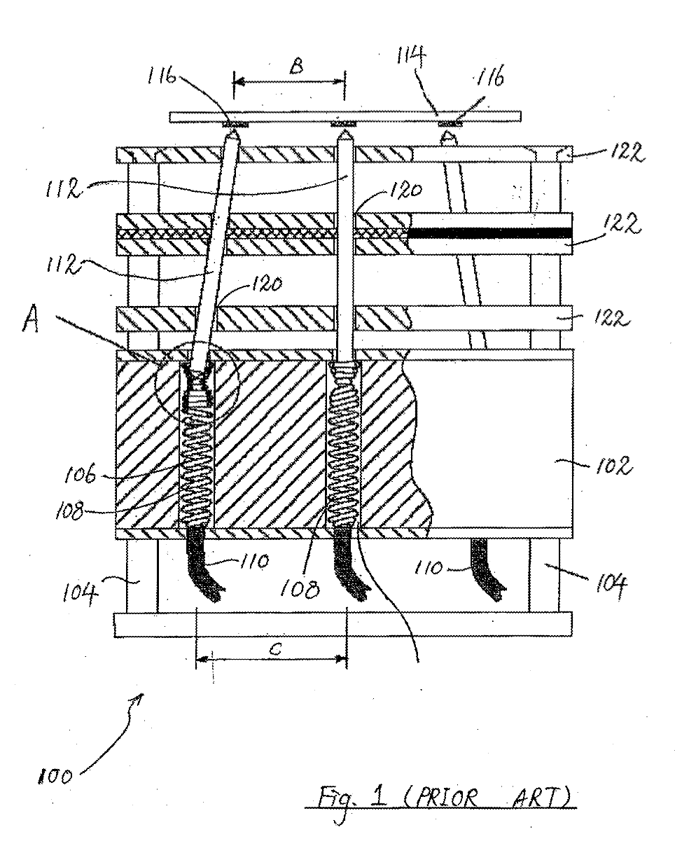

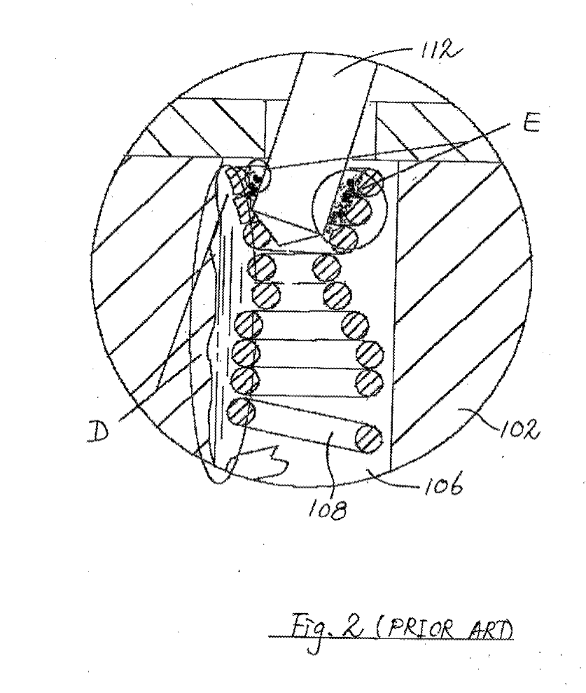

### DETAILED DESCRIPTION OF THE PREFERRED EMBODIMENT

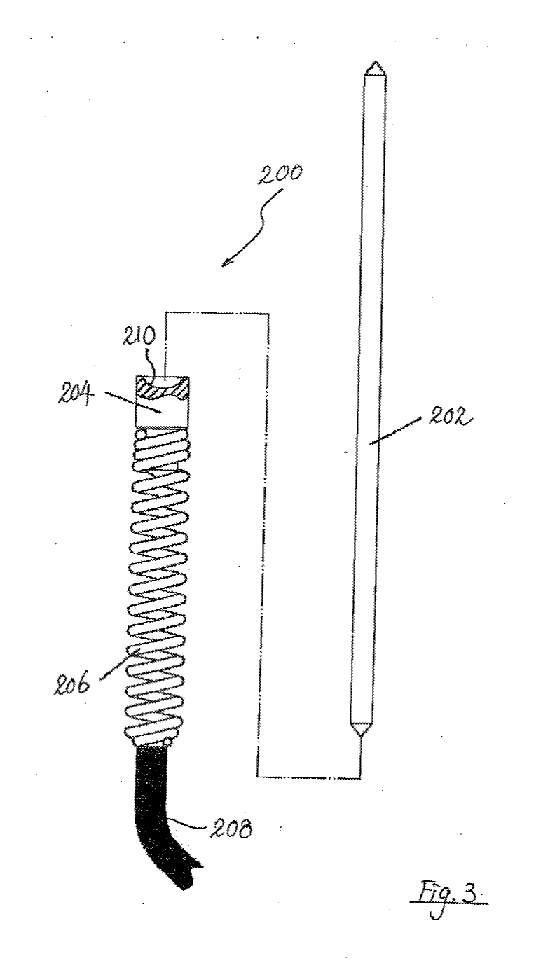

A testing pin assembly according to a preferred embodiment of the present invention is shown in FIG. 3, and generally designated as 200.

The testing pin assembly 200 includes an electrically conducting testing pin 202, an electrically conducting connector 204 and an electrically conducting spring 206. A lower end of the spring 206 is connected with an electric cable 208 for receiving electricity therefrom.

A lower end of the pin 202 sits on and is movable relative to a recessed concave upper surface 210 of the connector 204. A lower end of the connector 204 has a cylindrical part 212 with a downwardly pointing conical tip 214 (see FIG. 5). The cylindrical part 212 with the conical tip 214 is received within a cavity of the upper end of the spring 206. For securing the connector 204 with the spring 206, the cylindrical part 212 of the connector 204 has an annular trough 216 of a reduced diameter for engagement with the upper end of the spring 206.

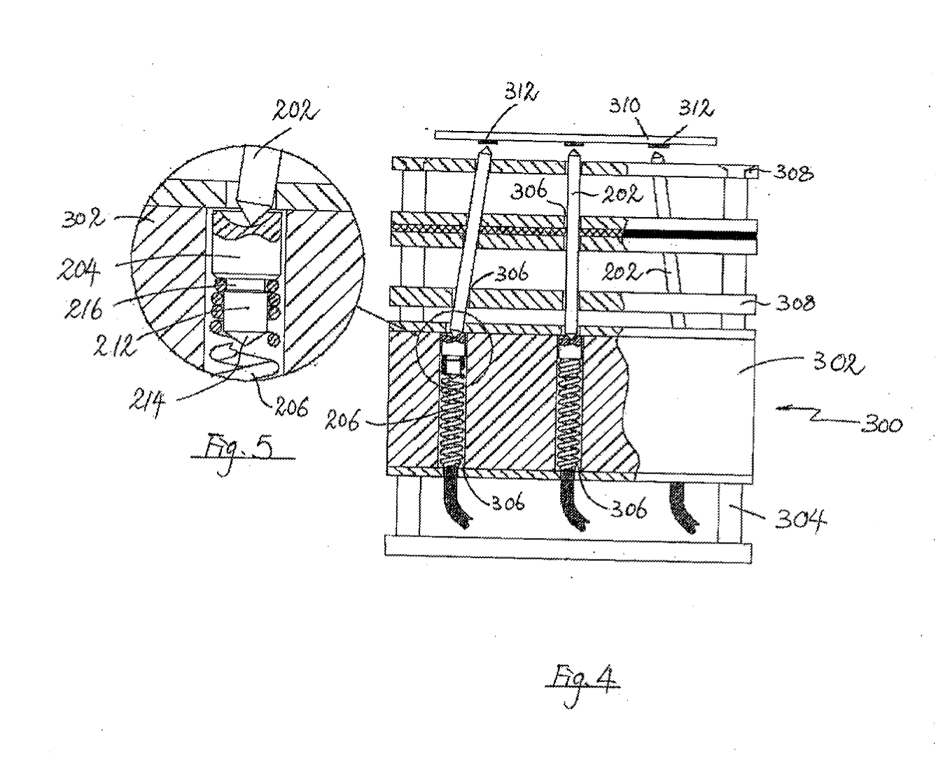

As shown in FIGS. 4 and 5, a modular apparatus for testing PCB's generally designated as 300 includes a base 302 supported by a number of supporting columns 304. Within the base 302 are a number of vertical cylindrical through-holes 306, each receiving a spring 206 of a respective pin assembly 200. Pins 202 connected with the respective connector 204 of the pin assembly 200 extend through openings 306 in a number of platforms 308.

During testing, a PCB 310 to be tested is pressed downwardly so that points 312 to be tested are brought into physical and electrical contact with upper ends of the pins 202. If necessary, the lower end of the pin 202 may move, e.g. slide, on the upper surface 210 so that the upper end of the pin 202 may contact the points 312 to be tested, while ensuring that the pin 202 remains electrically connected with the connector 204, and thus with the respective spring 206. Electricity may therefore be supplied by the cables 208 to the points 312 for testing purposes. The engagement between the spring 206 and the trough 216 of the connector can prevent loosening of these two parts. By way of such an arrangement, the pressure exerted by the PCB 310 to be tested can be evenly distributed to the springs 206.

After testing, the PCB 310 is moved upwardly away from the pins 202, and the pins 202 will return to their normal upstanding position by the biasing force of the springs 206.

It should be understood that the above only illustrates an example whereby the present invention may be carried out, and that various modifications and/or alterations may be made thereto without departing from the spirit of the invention. It should also be understood that certain features of the invention, which are, for brevity, described in the context of a single embodiment, may be provided separately or in any appropriate sub-combinations.

1. A testing pin assembly including a pin member with a lower end, and a spring member electrically connected with said pin member via a connector, wherein said connector includes an upper surface electrically connected with said lower end of said pin member, and wherein a lower end of said connector is at least partly received within a cavity of a first end of said spring member.

2. An assembly according to claim 1 wherein said connector is electrically conductive.

3. An assembly according to claim 1 wherein said upper surface of said connector is convex.

4. An assembly according to claim 1 wherein said lower end of said pin member is movable on said upper surface of said connector.

5. An assembly according to claim 1 wherein said lower end of said connector is generally cylindrical in shape.

6. An assembly according to claim 5 wherein said lower end of said connector includes an annular trough for receiving at least part of said spring member.

7. An apparatus for testing printed circuit boards, including a testing pin assembly according to claim 1, wherein said spring member and said connector are housed within a base member, and wherein said pin member extends through an opening of a platform member.

8. An apparatus according to claim 7 wherein said pin member extends through a respective opening of a plurality of platform members.
